(19) United States
(12) Patent Application Publication
(10) Pub. No.: US 2012/0179858 A1
(43) Pub. Date: Jul. 12, 2012

(54) MEMORY DEVICE

(75) Inventors: Toshiyuki MIYASHITA, Kanagawa (JP); Kazumasa Kitamura, Kanagawa (JP)

(73) Assignee: Kabushiki Kaisha Toshiba, Tokyo (JP)

(21) Appl. No.: 13/226,832

(22) Filed: Sep. 7, 2011

(30) Foreign Application Priority Data
Jan. 7, 2011 (JP) 2011-002393

(51) Int. Cl. G06F 12/00

(52) U.S. Cl. 711/103; 711/E12.008

(57) ABSTRACT

A memory card of the present embodiment includes a memory section configured to have a non-volatile semiconductor memory cell, an erasure setting section whose physical state changes irreversibly and a memory controller configured to perform total erasure processing of erasing all data stored in the memory section according to the physical state of the erasure setting section.

### CROSS REFERENCE TO RELATED APPLICATION

This application claims the benefit of Japanese Application No. 2011-002393 filed in Japan on Jan. 7, 2011, the contents of which are incorporated herein by this reference.

### FIELD

Embodiments described herein relate generally to a memory device that stores data in a non-volatile memory section.

### BACKGROUND

Memory devices such as memory cards that store data in a non-volatile memory section are becoming widespread as external storage devices for a host such as a personal computer, cellular phone or digital camera.

The memory section of a memory device includes a data storage region that stores data and a management region. In normal data erasure processing, it seems to a user as if data were erased, but what actually happens is nothing more than that management information stored in the management region is updated. That is, the data stored in the data storage region is not erased.

It is possible to erase the data stored in the data storage region and the management region of the memory device, that is, all data by issuing one command. However, erasure processing for all data takes a long time.

### BRIEF DESCRIPTION OF THE DRAWINGS

FIG. 1 is a configuration diagram of a memory card according to a first embodiment;

FIG. 2 is another configuration diagram of the memory card according to the first embodiment;

FIG. 3A is an outline view of the memory card according to the first embodiment;

FIG. 3B is another outline view of the memory card according to the first embodiment;

FIG. 4A is an outline view of a memory card according to a modification example 1 of the first embodiment;

FIG. 4B is another outline view of the memory card according to the modification example 1 of the first embodiment;

FIG. 5A is an outline view of a memory card according to a modification example 2 of the first embodiment;

FIG. 5B is another outline view of the memory card according to the modification example 2 of the first embodiment;

FIG. 6 is a configuration diagram of a memory card according to a second embodiment; and

FIG. 7 is a configuration diagram of a memory card according to a third embodiment.

### DETAILED DESCRIPTION

### First Embodiment

Hereinafter, a memory card 2, which is a memory device according to a first embodiment of the present invention, will be described.

The memory card 2, which is a memory device according to an aspect of the present invention, is provided with a memory section having a non-volatile semiconductor memory cell, an erasure setting section whose physical state changes irreversibly and a memory controller that performs erasure processing of erasing all data stored in the memory section according to the physical state of the erasure setting section.

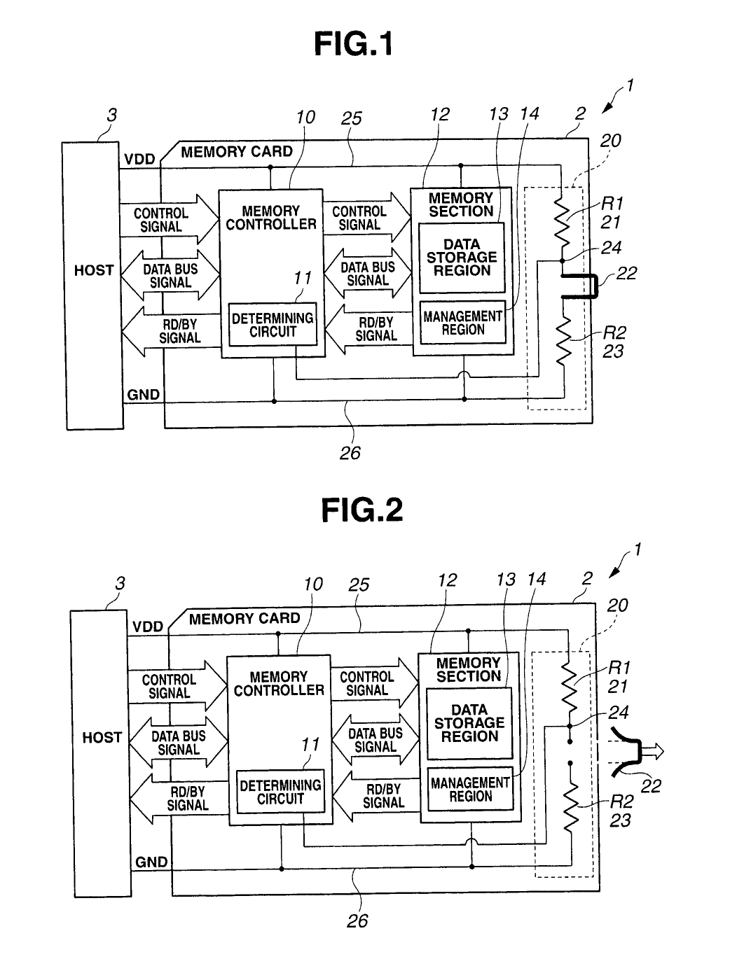

As shown in FIG. 1, the memory card 2 together with a host 3 constitutes a memory system 1. The host 3 is a personal computer, digital camera or the like and the memory card 2 is, for example an SD memory card (registered trademark) detachably connected to the host 3.

The memory device may also be a so-called embedded type or SSD (Solid State Drive) accommodated inside the host for storing startup data or the like of the host.

As shown in FIG. 1, the memory card 2 includes a memory controller 10, a memory section 12 and an erasure setting section 20. The memory controller 10 includes a CPU (not shown) that controls the entire memory card 2. The memory section 12 is a non-volatile semiconductor memory section.

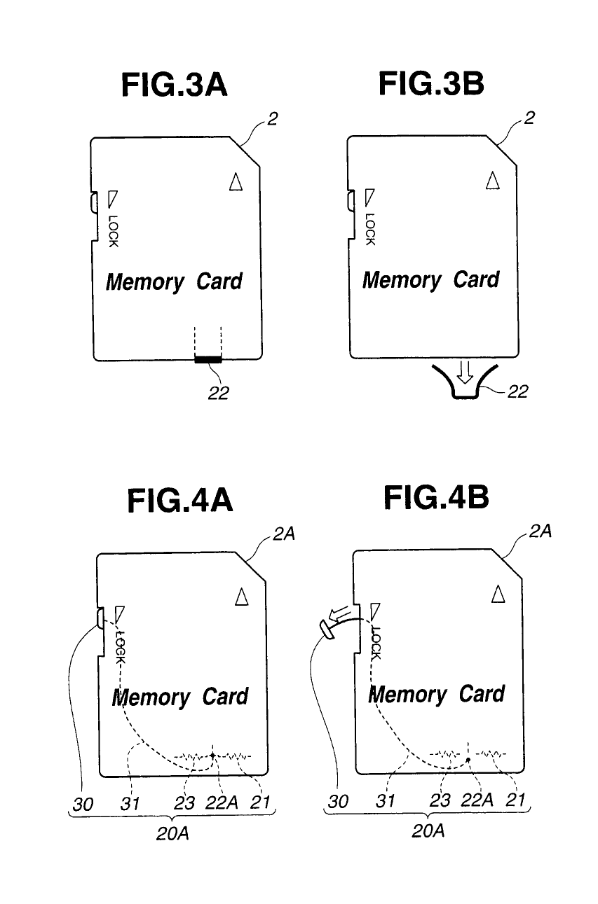

The erasure setting section 20 has a pin 22, which is a wiring section that can be pulled out from a housing of the memory card 2. As shown in FIG. 2, FIG. 3A and FIG. 3B, when the memory card 2 is disposed of, the pin 22 is pulled out from the memory card 2. In other words, the pin 22 is removed, that is, the erasure setting section 20 is set to be erased through a change in the physical state from “with pin” to “without pin.” The removed pin 22 cannot be reinserted into the memory card 2 and it is not possible to restore the once set erasure setting section 20 to be erased to the original physical state thereof. That is, the physical state of the erasure setting section 20 changes irreversibly.

As will be described in detail later, the memory card 2 whose erasure setting section 20 is set to be erased due to a physical change can be protected from data leakage.

As shown in FIG. 1, when the memory card 2 is connected to the host 3, power at a voltage V is supplied not only to the memory controller 10 and the memory section 12 of the memory card 2 but also to the erasure setting section 20 via a VDD line 25 and a GND line 26.

The data from the host 3 is stored in the data storage region 13 via the memory controller 10 as a data bus signal. Furthermore, a data read signal (command) or the like from the host 3 is transmitted to the memory section 12 via the memory controller 10 as a control signal. The memory section 12 transmits a BUSY signal (BY signal) indicating that the memory card is in a write/read processing state or a READY signal (RD signal) indicating that the memory card is in a processing acceptable state to the host 3 via the memory controller 10.

The memory section 12 is made up of NAND-type memory cells which are many non-volatile semiconductor memory cells. The memory section 12 includes a data storage region 13 for storing data and a management region 14 that stores information for managing the data stored in the data storage region 13.

The management region 14 stores, for example, a file management table such as FAT (File Allocation Tables) or NTFS (NT File System).

Upon receiving a normal data erasure processing command from the host 3 as a control signal as input, the memory controller 10 erases, not the data stored in the data storage region 13, but only management information of the data to be subjected to erasure processing of the file management table stored in the management region 14. This is because it takes a long time to actually perform erasure processing for all data stored in the data storage region 13.

However, since the user keeps track of the data stored in the data storage region 13 based on the file management table, the data is recognized as if it were erased.

The erasure setting section 20 of the memory card 2 is a voltage dividing circuit including a first resistor 21, a second resistor 23, a pin 22, which is a wiring section connecting the first resistor 21 and the second resistor 23. The pin 22 is made up of a conductor, at least part of which connects the first resistor 21 and the second resistor 23 and is disposed closer to the second resistor 23 than a midpoint 24.

One end of the first resistor 21 is connected to the VDD line 25 and one end of the second resistor 23 is connected to the GND line 26. A divided voltage signal, that is, the voltage at the midpoint 24 of the voltage dividing circuit is inputted to a determining circuit 11, which is a determining section of the memory controller 10 as a “CON_ERASE signal.”

Although FIG. 1 or the like shows the determining circuit 11 as one component of the memory controller 10, a part of the determining circuit 11 may also be a program that operates by being read by a CPU that makes up the memory controller 10 or another part of the determining circuit 11 may be an external circuit of the memory controller 10.

As shown in FIG. 2, FIG. 3A and FIG. 3B, the user can pull out the pin 22, part of which is exposed to the outer surface of the memory card 2. At least a part of the pin 22 exposed to the outer surface is preferably a nonconductive material. That is, the pin 22 is preferably made up of a portion made of a conductive material and a portion made of a nonconductive material or the portion exposed to the outer surface is preferably coated with a nonconductive material.

Once pulled out, the pin 22 is deformed considerably by an elastic force, and therefore the user cannot reinsert the pin 22 into the memory card 2. Furthermore, the presence or absence of the pin 22 of the memory card 2, that is, the physical state of the erasure setting section 20 is externally observable.

During normal use, the pin 22 may be located, for example, beneath a label affixed to the memory card 2 so as not to be externally observable. In the case of disposal, since the label is peeled first, the presence or absence of the pin 22 becomes recognizable.

Here, erasure operation of the memory card 2 will be described. In a normal state, that is, in a state in which there is the pin 22 whose erasure setting section 20 is not set to be erased, the signal level of the voltage signal (CON_ERASE signal) inputted to the determining circuit 11 is L level (normal operation level) of V×(1/6) assuming, for example, that the resistance value R1 of the first resistor 21 is 5MΩ and the resistance value R2 of the second resistor 23 is 1MΩ.

In the normal operation state, in order to reduce power consumption in the erasure setting section 20, the resistance value R1 of the first resistor 21 and the resistance value R2 of the second resistor 23 are preferably as high as, for example, 0.5MΩ or greater.

Upon detecting that the “CON_ERASE signal” is L level, the determining circuit 11 of the memory controller 10 determines that the memory card is, not in a discarded state but in a normal operation state. For this reason, the memory controller 10 does not perform any special processing.

The user needs only to pull out the pin 22 when disposing of the memory card 2. That is, it is not necessary to erase all data (management information+data stored in the data storage region) of the memory section 12 using an all data erasure processing command transmitted from the host 3. For this reason, the data leakage prevention function of the memory card 2 has a high level of convenience.

A possibility that the discarded memory card 2 may be picked up by a malicious third party and the data thereof may be browsed cannot be denied. However, most of the discarded memory cards 2 are disposed of without the data thereof being leaked.

It is not until the memory card 2 is picked up by the third party and connected to the host to browse the data therein that the memory card exerts the data leakage prevention function thereof.

That is, as shown in FIG. 2, when the memory card 2 whose pin 22 is pulled out is connected to the host, the “CON_ERASE signal” inputted to the determining circuit 11 has a voltage V of H level (discarded state level).

The L level and H level of the “CON_ERASE signal” are determined by a relationship between the resistance value R1 of the first resistor 21 and the resistance value R2 of the second resistor 23. To increase the level difference, the relationship is preferably R1>>R2.

Upon detecting that the “CON_ERASE signal” is not at a normal operation state level, the determining circuit 11 of the memory controller 10 determines that the memory card 2 is in a discarded state. The determining circuit 11 may also detect that the “CON_ERASE signal” is at H level, that is, at a discarded state level, but it is preferable to detect that the “CON_ERASE signal” is not at L level, that is, the “CON_ERASE signal” is not at a normal operation state level.

When the determining circuit 11 detects that the voltage signal is not at normal operation state level and thereby determines a discarded state, the memory controller 10 automatically performs total erasure processing of erasing all data stored in the memory section 12. For this reason, even when the memory card 2 is connected to the host, the data stored in the memory section 12 is never read out.

The total erasure processing executed by the memory controller 10 may be processing executed by issuance of one internal command or may be processing executed by issuance of a plurality of internal commands based on management information stored in the management region 14. However, even the total data erasure processing is not required to erase data other than that stored through the user's operation, for example, data stored before shipment.

As described above, the memory card 2 has a highly convenient data leakage prevention function. That is, it is not until there is a possibility of leakage, that is, the memory card 2 disposed of is connected to the host that the data leakage prevention function of the memory card 2 functions. For this reason, although the user need not perform erasure processing of erasing all data, which would require a long time before disposal, the data stored in the memory card 2 is never leaked. Furthermore, since the presence or absence of the pin 22 of the memory card 2 is externally observable, the user can ensure that the erasure setting section 20 of the memory card 2 is set to be erased.

### Modification Example of First Embodiment

Hereinafter, memory cards 2A and 2B in a modification example of the first embodiment of the present invention will be described with reference to the accompanying drawings. Since the memory cards 2A and 2B are similar to the memory card 2 of the first embodiment, descriptions of the same components will be omitted.

As shown in FIG. 4A, a wiring section 22A that connects the first resistor 21 and the second resistor 23 of an erasure setting section 20A of the memory card 2A in the modification example 1 of the first embodiment is connected to an erroneous erasure prevention notch 30 via a wire 31.

The erroneous erasure prevention notch 30 on one side of the housing of the memory card 2A is a member that disables deletion/overwrite of data by sliding downward during normal operation. The position of the erroneous erasure prevention notch 30 is physically detected by the host 3 and the erroneous erasure prevention notch 30 is not connected to any internal electric circuit of the memory card 2A.

As shown in FIG. 4B, removing the erroneous erasure prevention notch 30 at the time of disposal causes the wiring section 22A connected to the erroneous erasure prevention notch 30 via the wire 31 to be disconnected. In FIG. 4B, the wire 31 and the wiring section 22A are inside the memory card 2A, but they may be separated from the memory card 2A. That is, the wire 31 and the wiring section 22A may be removed together with the erroneous erasure prevention notch 30 as components independent of the memory card 2A.

That is, in the memory card 2A, erasure setting of the erasure setting section 20A is performed using the erroneous erasure prevention notch 30 and the physically disconnected wiring section 22A cannot be reconnected. Furthermore, the presence or absence of the erasure setting can be judged from the appearance of the erroneous erasure prevention notch 30.

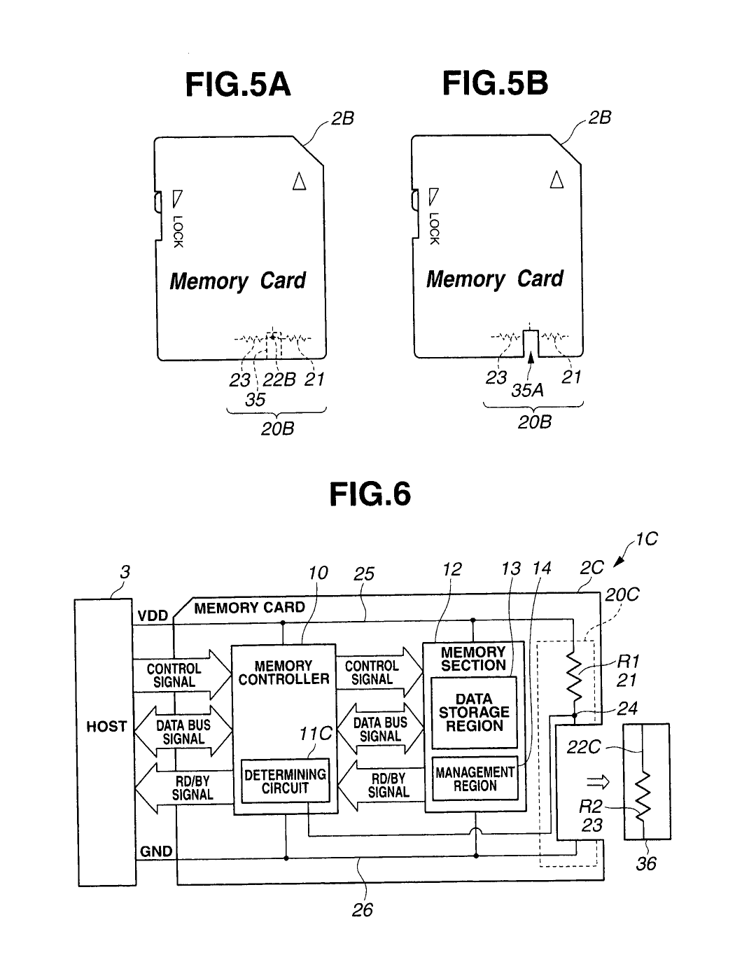

On the other hand, a wiring section 22B of an erasure setting section 20B of a memory card 2B in a modification example 2 of the first embodiment is disposed in a region where part of the housing can be physically removed, that is, a removal enabled section 35 as shown in FIG. 5A. In the removal enabled section 35, for example, resin making up the housing is formed to be thinner than the rest of the region.

As shown in FIG. 5B, at the time of disposal, the wiring section 22B is disconnected, the removal enabled section 35 is removed and a notch portion 35A is formed.

That is, in the memory card 2B, erasure setting of the erasure setting section 20B is performed using the removal enabled section 35 and the disconnected wiring section 22B cannot be reconnected. Furthermore, the presence or absence of the erasure setting can be judged from the appearance of the removal enabled section 35.

The memory card 2A in the modification example 1 and the memory card 2B in the modification example 2 have effects similar to those of the memory card 2 of the first embodiment.

That is, when the wiring sections 22A and 22B of the voltage dividing circuit are disconnected/removed, the “CON_ERASE signal” becomes H level. For this reason, when connected to the host, the memory controller 10 performs total erasure processing, and therefore data stored in the memory section 12 is never read out.

As described above, the configuration of the erasure setting section of the memory card needs only to be such a configuration that the physical state changes irreversibly.

### Second Embodiment

A memory card 2C of a second embodiment of the present invention will be described with reference to the accompanying drawings. Since the memory card 2C is similar to the memory card 2 or the like of the first embodiment, descriptions of the same components will be omitted.

As shown in FIG. 6, in an erasure setting section 20C of the memory card 2C, a wiring section 22C and a removal enabled section 36 including a second resistor 23 can be removed.

At the time of disposal, when the removal enabled section 35 is removed, the wiring section 22C is disconnected and the wiring section 22C together with the second resistor 23 becomes a component independent of the memory card 2C. Then, the “CON_ERASE signal” changes from L1 level to H1 level of a voltage V.

When the voltage signal (CON_ERASE signal) is at a normal operation state level, that is, not at L1 level corresponding to the resistance value R2, the determining circuit 11C determines that the memory card is in a discarded state. The level of the voltage signal is preferably judged by taking account of an error with respect to a predetermined value. For example, the determining circuit 11C preferably determines that the memory card is in a discarded state when the “CON_ERASE signal” is at a voltage outside a range of ±10% of the normal operation state level.

With the memory card 2C, even in case a third party with high technological skills attempts to restore the erasure setting section 20C to its original state, the third party does not know the resistance value R2 of the second resistor 23.

For this reason, not only when the third party attempts to re-connect the erasure setting section 20C without using the second resistor 23, but also when the third party attempts to re-connect a resistor of a different resistance value as the second resistor 23, when the memory card 2C is connected to the host, the memory controller 10 thereof performs total erasure processing.

The removal enabled section 35 may include not only the second resistor 23 but also the first resistor 21 or may include only the first resistor 21. That is, at least one of the first resistor 21 and the second resistor 23 needs only to be removable together with the wiring section 22C.

The memory card 2C has effects of the memory card 2 or the like and provides higher security.

### Third Embodiment

Hereinafter, a memory card 2D according to a third embodiment of the present invention will be described with reference to the accompanying drawings. Since the memory card 2D is similar to the memory card 2 or the like of the first embodiment, descriptions of the same components will be omitted.

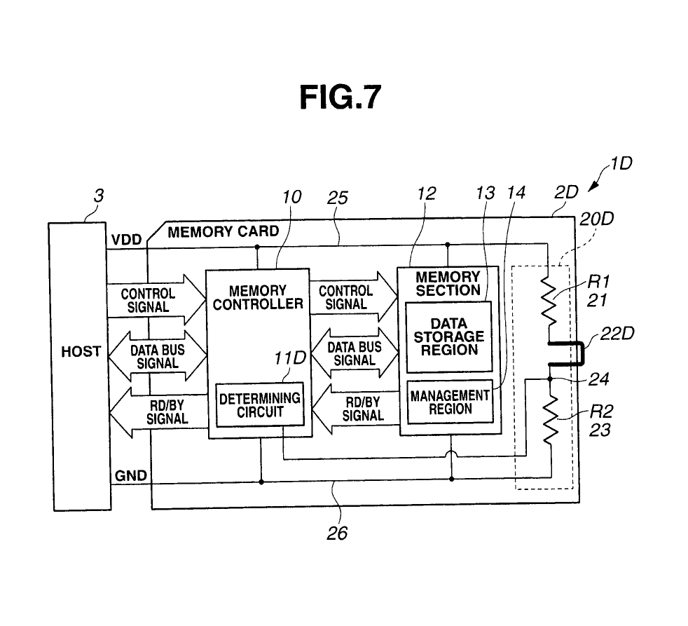

As shown in FIG. 7, in an erasure setting section 20D of the memory card 2D, a pin 22D which is a wiring section that can be disconnected or removed is disposed closer to the first resistor 21 than the midpoint 24.

For this reason, when the wiring section 22D is disconnected or removed, a voltage signal (CON_ERASE signal) changes from a normal operation state level (H2 level) to a discarded state level (L2 level). When, for example, the resistance value R1 of the first resistor 21 is 1MΩ and the resistance value R2 of the second resistor 23 is 5MΩ, the voltage of H2 level is V×(1/6) and the voltage of L2 level is 0V.

Upon detecting that the “CON_ERASE signal” is at normal operation state level (H2 level), a determining circuit 11D determines that the memory card is not in a discarded state. For this reason, the memory controller 10 does not perform any special processing. On the other hand, upon detecting that the “CON_ERASE signal” is not at normal operation state level, the determining circuit 11D determines that the memory card 2D is in a discarded state. When the determining circuit 11D determines the discarded state, a memory controller 10D performs total erasure processing of erasing all data stored in the memory section 12. The memory card 2D has effects similar to those of the memory card 2 or the like.

The erasure setting method of the erasure setting section 20D of the memory card 2D may be the same as those in the modification examples 1 and 2 of the first embodiment described above. Furthermore, as shown in the second embodiment, at least one of the first resistor 21 and the second resistor 23 together with the wiring section may also be removable.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A memory device comprising:
a memory section configured to have a non-volatile semiconductor memory cell;
an erasure setting section whose physical state changes irreversibly; and
a memory controller configured to perform total erasure processing of erasing all data stored in the memory section according to the physical state of the erasure setting section.

2. The memory device according to claim 1, wherein the erasure setting section comprises a voltage dividing circuit configured to output a voltage signal, voltage-divided by a plurality of resistors, which varies depending on the physical state, and
the memory controller comprises a determining section configured to determine the physical state of the erasure setting section based on the voltage signal.

3. The memory device according to claim 2, wherein when the voltage signal is not at a normal operation level, the memory controller performs the total erasure processing.

4. The memory device according to claim 3, wherein the voltage dividing circuit comprises a first resistor, a second resistor and a wiring section that connects the first resistor and the second resistor, the wiring section being able to be disconnected or removed, and
the physical state corresponds to a disconnected or a removed state of the wiring section.

5. The memory device according to claim 4, wherein the physical state of the erasure setting section is externally observable.

6. The memory device according to claim 5, wherein the wiring section is a pin that can be pulled out from a housing and cannot be reinserted once pulled out.

7. The memory device according to claim 6, wherein at least a surface of a portion of the pin exposed to an outer surface from the housing is a nonconductive material.

8. The memory device according to claim 5, further comprising an erroneous erasure prevention notch in the housing,
wherein the wiring section connected to the erroneous erasure prevention notch via a wire is disconnected when the erroneous erasure prevention notch is removed from the housing.

9. The memory device according to claim 5, wherein the wiring section disposed in a removal enabled section of the housing is removed by removal of the removal enabled section.

10. The memory device according to claim 9, wherein when a notch portion is formed in the housing due to removal of the removal enabled section, at least one of the first resistor and the second resistor is removed together with the wiring section.
